(19) United States
(12) Patent Application Publication
(10) Pub. No.: US 2008/0250177 A1
(43) Pub. Date: Oct. 9, 2008

(54) MEMORY DEVICE INCLUDING CONNECTOR FOR INDEPENDENTLY INTERFACING HOST AND MEMORY DEVICES

(76) Inventors: Min-Soo Kang, Yongin-si (KR); Joong Chul Yoon, Seoul (KR); Seok-Won Heo, Seoul (KR)

Correspondence Address: F. CHAU & ASSOCIATES, LLC, 130 WOODBURY ROAD, WOODBURY, NY, 11797, US

(21) Appl. No.: 12/062,078

(22) Filed: Apr. 3, 2008

(30) Foreign Application Priority Data
Apr. 4, 2007 (KR) 10-2007-0033069

(51) Int. Cl. G06F 13/42

(52) U.S. Cl. 710/105

(57) ABSTRACT

A memory device including a connector for independently interfacing a host and memory devices using a multimedia card (MMC) protocol is provided. The memory device includes an internal bus and a connector. The internal bus is configured to receive a command or data from the host via a plurality of input/output pins. The connector is electrically connected with the internal bus and connected with another memory device, which interfaces with the host through the internal bus using the MMC protocol.

### CROSS-REFERENCE TO RELATED PATENT APPLICATION

This application claims priority to Korean Patent Application No. 10-2007-0033069, filed on Apr. 4, 2007, in the Korean Intellectual Property Office, the disclosure of which is incorporated by reference its entirety herein.

### BACKGROUND OF THE INVENTION

1. Technical Field

The present disclosure relates to a memory device using a multimedia card (MMC) protocol, and more particularly, to a memory device for interfacing a host and memory devices using the MMC protocol, a memory device module including the memory device, and a system including the memory device module.

2. Discussion of Related Art

With the recent development of storage media technology, a variety of memory devices (e.g., non-volatile memory devices), which are used as auxiliary memory devices for portable devices such as mobile phone and digital cameras, have been manufactured. Compact flash (CF), multimedia cards (MMCs), smart media cards (SMCs), and secure digital (SD) cards are examples of the memory devices. The memory devices are suitable as data storage devices for portable devices such as mobile phones because they have a small size and a light weight.

The memory devices may be connected to a host (e.g., a computer) via a system bus. The memory devices and the host communicate data between one another using a predetermined protocol (e.g., an MMC protocol or an SD protocol). The host may provide a slot for the connection with a memory device according to the size of the memory device.

FIG. 1 illustrates conventional memory devices 110 and 120, which may use the MMC protocol. Referring to FIG. 1, each of the memory devices 110 and 120 may be an MMC. The MMC may be a normal size MMC 110 or a reduced size MMC (RS-MMC) 120 according to its size. The normal size MMC 110 can be connected with a host like a digital camera and the RS-MMC 120 can be connected with a host like a mobile phone.

A host may only provide a single slot matched with the size of an MMC connected thereto. For example, if a host only provides a slot sized for the normal sized MMC 100, the RS-MMC 120 may be connected to the slot by coupling a dummy form factor 125 to the RS-MMC 120, as illustrated in FIG. 1.

Conventionally, memory can only be extended in a host providing a single slot by replacing an existing memory card with a new memory card having a larger capacity. For example, when an RS-MMC coupled with a dummy form factor is used in a host like a digital camera, the existing RS-MMC needs to be replaced with a larger capacity RS-MMC for memory extension.

Thus, there is a need to a memory device that can be interfaced with a host independently of the current slots provided by the host.

### SUMMARY OF THE INVENTION

Exemplary embodiments of the present invention provide a memory device including a connector for allowing connection between memory devices using a multimedia card (MMC) protocol for memory extension and for independently interfacing a host and each of the memory devices, a memory device module including the memory device, and a system including the memory device module.

According to an exemplary embodiment of the present invention, a memory device is provided which is interfaced with a host using an MMC protocol. The memory device includes an internal bus configured to receive a command or data from the host via a plurality of input/output pins and a connector electrically connected with the internal bus and connected with a second memory device which is interfaced with the host using the MMC protocol.

According to an exemplary embodiment of the present invention, there is provided a memory device module which is interfaced with a host using the MMC protocol. The memory device module includes a first memory device and a second memory device. The first memory device includes a first internal bus connected with the host via a plurality of input/output pins and a first connector electrically connected with the first internal bus. The second memory device includes a second connector connected with the first connector and a second internal bus electrically connected with the second connector. The second memory device is interfaced with the host independently of the first memory device via the first and second internal buses and the first and second connectors using the MMC protocol.

According to an exemplary embodiment of the present invention, a system using an MMC protocol includes a host, a first memory device, and a second memory device. The first memory device includes a first internal bus connected with the host via a plurality of input/output pins and a first connector electrically connected with the first internal bus. The second memory device includes a second connector connected with the first connector and a second internal bus electrically connected with the second connector. The host is independently interfaced with the first memory device and the second memory device using the MMC protocol.

The host may be independently interfaced with the first memory device and the second memory device via the first and second internal buses and the first and second connectors using the MMC protocol.

According to an exemplary embodiment of the present invention, a method of driving memory devices connected together through connectors and corresponding internal busses, wherein one of the memory devices is connected to a host, includes the host using a multimedia card (MMC) protocol to send a request for a card identification (CID) number to each of the memory devices through at least one of the internal busses, at least one of the memory devices using the MMC protocol to respond to the request for a CID number across at least one of the internal buses, the host allocating a unique relative card address to at least one of the memory devices that responded, and the host sending data to at least one of the memory devices that was allocated a unique relative card address. The sending of data may include the host sending a command ordering the memory device to enter a transfer state and sending data to the memory device once it has entered the transfer state.

### BRIEF DESCRIPTION OF THE DRAWINGS

The present invention will become more apparent by describing in detail exemplary embodiments thereof with reference to the attached drawings in which:

FIG. 1 illustrates conventional memory devices using a multimedia card (MMC) protocol;

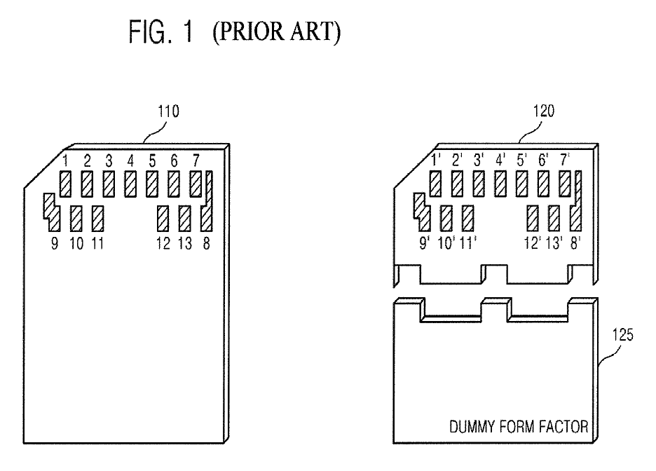

FIG. 2 illustrates an interface system using a MMC protocol, according to an exemplary embodiment of the present invention;

FIG. 3 illustrates a first memory device and a second memory device illustrated in FIG. 2;

FIG. 4 illustrates a two-way connector connecting a first connector and a second connector illustrated in FIG. 2, according to an exemplary embodiment of the present invention;

FIG. 5 illustrates a two-way connector connecting the first connector and the second connector illustrated in FIG. 2, according to an exemplary embodiment of the present invention; and

FIG. 6 illustrates signals transferred via a plurality of input/output pins illustrated in FIG. 3 according to an exemplary embodiment of the present invention.

### DETAILED DESCRIPTION OF EXEMPLARY EMBODIMENTS

The present invention now will be described more fully hereinafter with reference to the accompanying drawings, in which exemplary embodiments of the invention are shown. This invention may, however, be embodied in many different forms and should not be construed as limited to the embodiments set forth herein. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present.

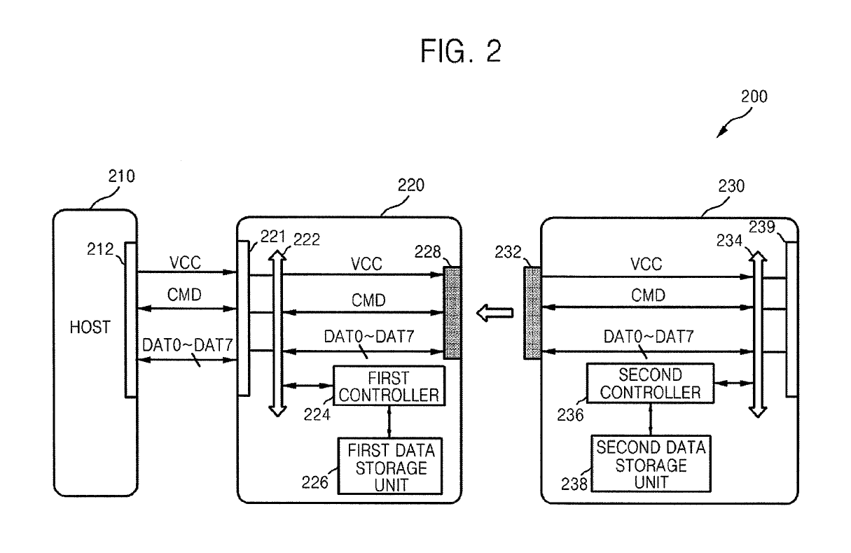

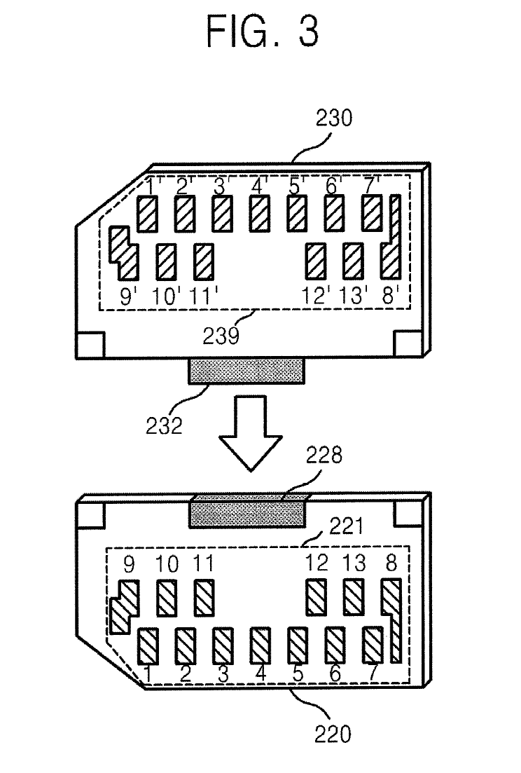

FIG. 2 illustrates an interface system 200 using a MMC protocol according to an exemplary embodiment of the present invention. FIG. 3 illustrates an embodiment of a first and second memory device of FIG. 2. Referring to FIG. 2 and FIG. 3, the system 200 includes a host 210, a first memory device 220 and a second memory device 230. The host 210 communicates with each of the first memory device 220 and the second memory device 230 using a multimedia card (MMC) protocol. The first memory device 220 and the second memory device 230 may be MMCs.

The first memory device 220 includes a first input/output unit 221 including a plurality of first input/output pins 1 through 13, a first internal bus 222, a first controller 224, a first data storage unit 226, and a first connector 228. The first input/output pins 1 through 13 are connected with the host 210 and are coupled to the first internal bus 222. A plurality of signals, for example, a command CMD, a power supply voltage VCC, and data DAT0 through DAT7, may be transmitted from the host 210 to the first internal bus 222 via the first input/output pins 1 through 13.

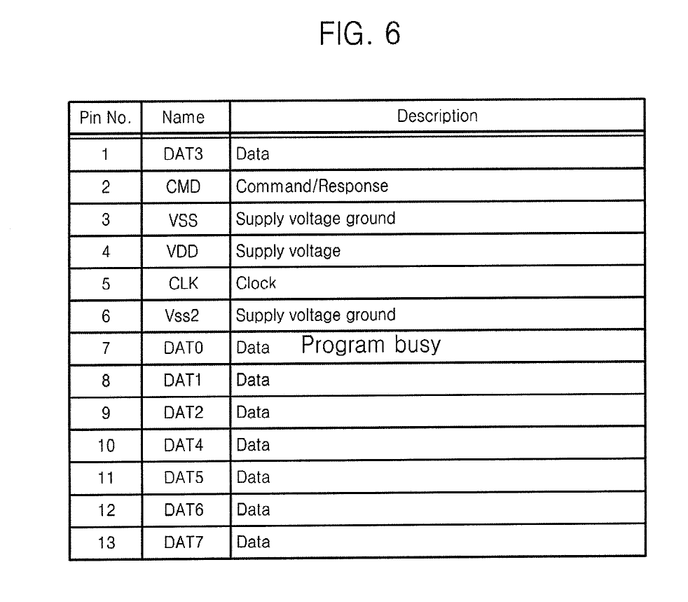

FIG. 6 illustrates signals that may be transferred via the input/output pins 1 through 13 illustrated in FIG. 3, according to an exemplary embodiment of the present invention. Referring to FIG. 6, the first memory device 220 can receive 8 bits of data DAT0 through DAT7, a clock signal CLK, a command CMD, and power supply voltages VCC (e.g., VSS, VDD, and Vss2) from the host 210 via the input/output pins 1 through 13. The first controller 224 outputs one or more control signals based on the command CMD transmitted from the host to the first internal bus 222. The first data storage unit 226 writes data transmitted from the host to the first internal bus 222, reads written data for transmission from the host to the first internal bus 222, or erases written data. The write, read, and erase may be based on at least one of the control signals.

The host 210 may include a memory device controller, for example, an MMC controller (not shown). The first data storage unit 226 may be implemented by non-volatile memory, for example, flash memory. The first connector 228 is electrically connected to the first internal bus 222.

The second memory device 230 includes a second connector 232, a second internal bus 234, a second controller 236, a second data storage unit 238, and a second input/output unit 239 including a plurality of second input/output pins 1′ through 13′. The second connector 232 is connected with the first connector 228 and is coupled to the second internal bus 234. The second internal bus 234 is connected with the second input/output unit 239 including the plurality of second input/output pins 1′ through 13′. The first connector 228 may be one among a plug and a socket and the second connector 232 may be the other one among them. The first connector 228 may also be one of a male and female connector and the second connector may be the other one among them.

The plurality of signals, for example, the command CMD, the power supply voltage VCC, and the data DAT0 through DAT7, transmitted from the host 210 to the first internal bus 222, are transmitted to the second internal bus 234 via the second connector 232 connected with the first connector 228. Bus communication through the first internal bus 222 and the second internal bus 234 may use an MMC bus protocol, enabling two-way data transmission to be performed between the host 210 and the memory devices 220 and 230. Consequently, the first memory device 220 and the second memory device 230 are connected with the host 210 via the first internal bus 222, the first connector 228, the second connector 232, and the second internal bus 234.

The host 210 recognizes the first memory device 220 and the second memory device 230 independently according to the MMC protocol. The interface system 200 may operate according to the MMC specification. For example, an operation mode of each of the first memory device 220 and the second memory device 230 may include a card identification mode and a data transfer mode.

When the second memory device 230 is connected to the first memory device 220 connected to the host 210 via the first internal bus 222, the first connector 228, the second connector 232, and the second internal bus 234, the host 210 performs a card identification mode process. The host 210 can request a card identification (CID) number from each of the first memory device 220 and the second memory device 230 during the card identification mode.

The host 210 allocates a relative card address (RCA) to each of the first memory device 220 and the second memory device 230 via the first internal bus 222, the first connector 228, the second connector 232, and the second internal bus 234 when the first memory device 220 and the second memory device 230 both successfully respond to the request of the host 210. The RCA allocated to the first memory device 220 may be referred to as RCA1 and the RCA allocated to the second memory device 230 may be referred to as RCA2.

Once the RCA is allocated to each of the first memory device 220 and the second memory device 230, the first memory device 220 and the second memory device 230 may enter a standby state and the operation mode may be converted from the CID mode into the data transfer mode. In the data transfer mode, the first memory device 220 and the second memory device 230 may have a variety of states including the standby state, a disconnect state, a transfer state, a sending data state, a receive data state, and a programming state.

The host 210 transmits a predetermined command (e.g., CMD7) including the RCA (e.g., RCA1 or RCA2) to the first memory device 220 and the second memory device 230 via the first internal bus 222, the first connector 228, the second connector 232, and the second internal bus 234. One memory device (e.g., the first memory device 220) corresponding to the RCA (e.g., RCA1) included in the transmitted command CMD7 is selected among the first memory device 220 and the second memory device 230, which are in the standby state. The selected memory device is converted from the standby state into the transfer state. When the command CMD7 including the RCA2 is transmitted to the first memory device 220 and the second memory device 230, the second memory device 230 is converted from the standby state into the transfer state and the first memory device 220 is converted from the transfer state into the disconnect state or standby state. In the interface system 200 using the MMC specification, only the memory device (e.g., the first memory device 220) among the first memory device 220 and the second memory device 230 that has entered the transfer state can perform an operation (e.g., a read, write, or erase operation) requested by the host 210 in response to the command CMD transmitted from the host 210. The other memory device (e.g., the second memory device 230) may be in the standby state or the disconnect state.

In another embodiment of the present invention, commands including both the RCA1 and RC2 may be sent respectively to the first memory device 220 and the second memory device 230, causing both to enter the transfer state, and enabling data to be written to, read from, or erased from each device together.

The second memory device 230 is connected with the first memory device 220 via the second connector 232 coupled to the second internal bus 234 and is connected with the host 210 via the first connector 228 and the first internal bus 222.

Due to the MMC protocol, the host 210 can independently recognize and can be selectively interfaced with the first memory device 220 and the second memory device 230. When the first memory device 220 and the second memory device 230 are connected to each other, they may be easily coupled to a single slot having a predetermined size in the host 210. The interface between the host 210 and each of the first memory device 220 and the second memory device 230 can be performed independently. Accordingly, memory may be extended in a host 210 without adding a new slot to the host 210 or replacing an existing memory device with a larger capacity memory device.

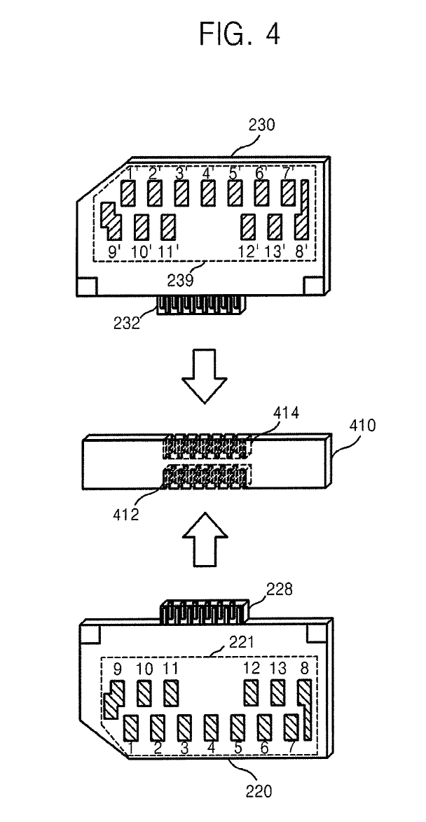

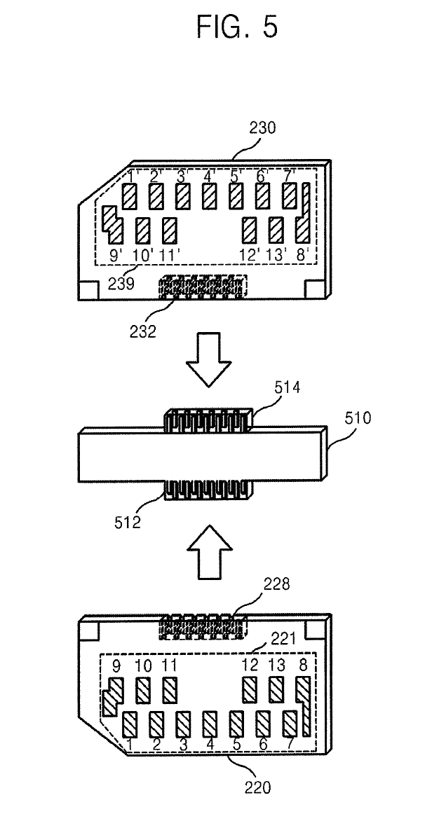

FIG. 4 illustrates a two-way connector 410 connecting the first connector 228 and the second connector 232 illustrated in FIG. 2, according to an exemplary embodiment of the present invention. FIG. 5 illustrates a two-way connector 510 connecting the first connector 228 and the second connector 232 illustrated in FIG. 2, according to an exemplary embodiment of the present invention.

Referring to FIG. 4, each of the first connector 228 and the second connector 232 may be implemented using a plug shape. The two-way connector 410 includes a first coupler 412 and a second coupler 414, which have a socket shape. Accordingly, the first connector 228 may be plugged into the first coupler 412 and the second connector 232 may be plugged into the second coupler 414.

Referring to FIG. 5, each of the first connector 228 and the second connector 232 may be implemented using a socket shape. The two-way connector 510 includes a first coupler 512 and a second coupler 514, which have a plug shape. Accordingly, the first coupler 512 may be plugged into the first connector 228 and the second coupler 514 may be plugged into the second connector 232.

As illustrated in FIGS. 4 and 5, the first connector 228 and the second connector 232 can be connected with each other by the two-way connector 410 or 510.

While the memory devices 220 and 230 of the present invention have been described as having 13 pins with 8 bits of data, the present invention is not limited thereto. For example, the memory devices may have a fewer or greater number of pins and a fewer or greater number of data bits. The memory devices may include an MMC, RS-MMC, MMC plus, a SecureMMC card, etc.

According to an exemplary embodiment of the present invention, a method of driving memory devices connected together through connectors and corresponding internal busses, wherein one of the memory devices is connected to a host, includes the host using a multimedia card (MMC) protocol to send a request for a card identification (CID) number to each of the memory devices through at least one of the internal busses, at least one of the memory devices using the MMC protocol to respond to the request for a CID number across at least one of the internal buses, the host allocating a unique relative card address to at least one of the memory devices that responded, and the host sending data to at least one of the memory devices that was allocated a unique relative card address. The sending of data may include the host sending a command ordering the memory device to enter a transfer state and sending data to the memory device once it has entered the transfer state.

It is to be understood that the methods described herein may be implemented in various forms of hardware, software, firmware, special purpose processors, or a combination thereof. The methods may be implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces.

According to at least one embodiment of the present invention, a memory device includes a connector for allowing another memory device using an MMC protocol to be connected thereto and enables the memory device connected to the connector to be connected with a host, thereby allowing the host to be independently and directly interfaced with the memory devices. Further, since the two memory devices connected with each other may be coupled to a single slot in the host, memory for the host can be more easily extended.

While the present invention has been shown and described with reference to exemplary embodiments thereof, it will be understood by those of ordinary skill in the art that various changes in form and detail may be made herein without departing from the spirit and scope of the present invention.

What is claimed is:

1. A memory device which is interfaced with a host using a multimedia card (MMC) protocol, the memory device comprising:
an internal bus configured to receive a command or data from the host via a plurality of input/output pins; and
a connector electrically connected with the internal bus and configured to be connected with a second memory device which interfaces with the host through the internal bus using the MMC protocol.

2. The memory device of claim 1, wherein the internal bus uses an MMC bus protocol.

3. The memory device of claim 1, further comprising:
a controller configured to output at least one control signal based on a command transmitted from the host via the plurality of input/output pins; and
a data storage unit configured to write the data or erase previously written data based on the at least one control signal.

4. The memory device of claim 1, wherein each of the memory devices comprises one of a MMC, RS-MMC, MMC plus, or SecureMMC card.

5. The memory device of claim 1, wherein the second memory device includes a second connector that is configured to detachably connect to the connector of the memory device.

6. The memory device of claim 5, wherein the second memory device includes a second bus that is electrically connected to the internal bus through the connector and the second connector.

7. The memory device of claim 1, wherein each of the memory devices are configured to respond with a unique card identification number when the host requests that the devices identify themselves.

8. The memory device of claim 7, wherein the host allocates a unique relative card address to each of the memory devices that responds with the unique card identification number.

9. A memory device module which is interfaced with a host using a multimedia card (MMC) protocol, the memory device module comprising:
a first memory device comprising a first internal bus connected with the host via a plurality of input/output pins and a first connector electrically connected with the first internal bus; and
a second memory device comprising a second connector connected with the first connector and a second internal bus electrically connected with the second connector,
wherein the second memory device is interfaced with the host independently of the first memory device via the first and second internal buses and the first and second connectors use the MMC protocol.

10. The memory device module of claim 9, wherein the first and second internal buses operate according to an MMC bus protocol.

11. The memory device module of claim 9, wherein the first connector is one among a plug and a socket and the second connector is the other one among the plug and the socket.

12. The memory device module of claim 9, further comprising a two-way connector configured to connect the first connector with the second connector.

13. The memory device module of claim 9, wherein the first connector includes one of a male connector and a female connector and the second connector is the other one among the male and female connector.

14. The memory device module of claim 9, wherein each of the memory devices comprises one of a MMC, RS-MMC, MMC plus, or SecureMMC card.

15. A system using a multimedia card (MMC) protocol, the system comprising:
a host;
a first memory device comprising a first internal bus connected with the host via a plurality of input/output pins and a first connector electrically connected with the first internal bus; and
a second memory device comprising a second connector connected with the first connector and a second internal bus electrically connected with the second connector,
wherein the host is independently interfaced with the first memory device and the second memory device using the MMC protocol.

16. The system of claim 15, wherein the host is independently interfaced with the first memory device and the second memory device via the first and second internal buses and the first and second connectors using the MMC protocol.

17. The system of claim 15, wherein the first and second internal buses operate according to an MMC bus protocol.

18. The system of claim 15, wherein each of the memory devices are configured to respond with a unique card identification number when the host requests that the devices identify themselves.

19. The system of claim 18, wherein the host is configured to allocate a unique relative card address to each of the memory devices that responds with the unique card identification number.

20. The system of claim 15, wherein each of the memory devices comprises one of a MMC, RS-MMC, MMC plus, or SecureMMC card.
